(19) United States
(12) Patent Application Publication
(10) Pub. No.: US 2012/0317162 A1
(43) Pub. Date: Dec. 13, 2012

(54) COMMUNICATION AND EXCHANGE OF GROUP-RELATED INFORMATION USING A CENTRAL SERVER

(75) Inventors: Jay Endsley, San Jose, CA (US); Alan Messer, Los Gatos, CA (US)

(73) Assignee: Samsung Electronics Co., Ltd., Suwon City (KR)

(21) Appl. No.: 13/158,083

(22) Filed: Jun. 10, 2011

(51) Int. Cl. G06F 15/16

(52) U.S. Cl. 709/201

(57) ABSTRACT

The present invention provides a service for sharing, managing, and storing group-related information using existing technology relating to mobile devices, TVs, server computers, and distributed networks. Users in a defined group, such a family, can use devices, such as smart phones or tablets, to get updates from other users or to send information about themselves. The information can be displayed on authorized devices, some of which are generally used to display information, such as TVs. The content type of the communication is determined. The communication is stored in a database on the central server if the communication is a broadcast message or an event message. If the communication is a query message, the central sever responds to the message. If it is an update message, the database in the central server is updated. The group information is displayed in real-time on one or more devices and is combined in one place.

### TECHNICAL FIELD

The present invention relates generally to computer hardware, mobile devices, televisions, and software. More specifically, it relates to managing and exchanging information shared by a defined group in a distributed network.

### BACKGROUND OF THE INVENTION

The sharing and management of information is becoming increasingly important in people's day-to-day lives. Individuals, whether they are members of a family, classmates, or co-workers, want to know more about what other individuals with whom they have a relationship or association are doing, where they are, what plans they are making, and so on. In many cases, people would like such notifications and information feeds to be non-intrusive and have a light touch or footprint to present being overwhelmed or constantly interrupted with such information.

Currently, information is shared among individuals using numerous communication channels, networks, and devices. The most significant trend in devices has been the proliferation of mobile devices, namely “smartphones” and tablet computing devices. These hand-held devices are what many people now use to get onto the Internet, play media, communicate, and run software (“apps” or software applications that execute on mobile devices and TVs), play media, and communicate. The use of these mobile devices is converging with other widely used devices, such as desktop and laptop computers, TVs, GPS devices, e-book readers, and the like. Out of all these devices, the TV is currently going through some major changes in how users interact with them. They are now used for more than simply watching network and cable TV content or DVDs. They are being used to run apps, get online, display photos and videos, and display content different from traditional broadcast media (e.g., TV shows, movies, or music). They are now being used to display personalized content. As such, it is increasingly being used with or integrated with other devices, especially with smart phones and tablet computers.

This convergence of mobile devices, TVs, and other components has given rise to opportunities for sharing and managing group-related information in ways that were previously impractical or technologically infeasible. Generally, it would be desirable for a group of registered users, utilizing various devices—some mobile and other traditionally stationary—to be able to exchange information and communicate in ways that are not intrusive and that integrate well with existing devices. It would be desirable to leverage existing devices, such as TVs, that are conventionally used for displaying content and expand their use to display group-related information to users, again, in an unobtrusive and well-integrated way.

### SUMMARY OF THE INVENTION

The present invention provides a service for sharing, managing, and storing group-related information using existing technology relating to mobile devices, TVs, server computers, and distributed networks. Users in a defined group, such a family or a group of co-workers, can use devices, such as smart phones or tablets, to get updates from other users or to send information about themselves. The information can be displayed on authorized devices, some of which are generally used to display information, such as TVs.

One aspect of the present invention is a method of managing group information stored on a central server. A header of a communication received from a device is examined at a central server. It is then determined whether the type of the communication is a broadcast message, an event message, a query message, or an update message. The communication is stored in a database on the central server if the communication is a broadcast message or an event message. If the communication is a query message, the central sever responds to the message. If it is an update message, the database in the central server is updated. The group information is displayed in real-time on one or more devices and is combined in one place.

Another aspect of the present invention is a method of managing group information on a device. A header of a communication received from a server is examined. It is then determined whether the type of the communication is a broadcast message or a response to a query, the response being sent by the central server or hub. A query response may be a calendaring event, location information, or a bulletin board item. The communication is then stored in the device database. In one embodiment, it may be determined that the user of the device is making an update to the group information. This update to the group information is stored in a local database and is transmitted to the server.

Another aspect of the present invention is a system for facilitating group information communication and management. The system includes a central server or hub having a database and a group information server or hub application set, wherein combined group information is stored in the database. It also includes one or more devices, where the devices display a group-information in various formats, such as a group information ticker on a TV and has a group information client application set. The system enables interactions among group members are simplified and integrated.

### BRIEF DESCRIPTION OF THE DRAWINGS

The invention and the advantages thereof may best be understood by reference to the following description taken in conjunction with the accompanying drawings in which:

FIG. 1 is a diagram showing a generic network configuration of a distributed network in which the present invention may be implemented;

FIG. 2 is an illustration showing the concept of a ticker displayed on a TV to convey information in accordance with the described embodiment;

FIG. 3 is a flow diagram of processes that execute on a central hub that relates to receiving communications from network devices accordance with one embodiment of the present invention;

FIG. 4 is a flow diagram of a process of a device connecting to a central server in accordance with one embodiment of the present invention;

FIG. 5 is a flow diagram of some typical operations that execute on a device;

FIG. 6 is a flow diagram showing a process of a background task maintaining location status on a mobile device;

FIG. 7 is a flow diagram of a process of providing location information in response to a server request;

FIG. 8 is a block diagram of a central server or hub shown FIG. 1; and

FIGS. 9A and 9B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF THE INVENTION

Methods and systems for sharing, managing, and storing information related to a group of individuals are described in the various figures. The invention enables these individuals (“users”) and their devices, to send messages, receive messages and updates, such as calendar or scheduling changes, provide location information, status, and the like, to other users, through a central server or hub. These communications may be displayed in various formats on a device that is predominantly used for display, such as a TV or a digital photo frame or on other devices, such as smartphones or tablets. The marketplace has many Internet-based services that offer messaging, calendar services, e-mail, chat, and other features to groups and businesses. The present invention combines key information relevant to a close group, such as a family, and integrates a set of features for that group. The group-information ticker is an example such a feature. The ticker, one embodiment of a broader concept is akin to an emergency alert that can be found on many TVs, but is applied to and displays group-related information. Details are provided in the description below.

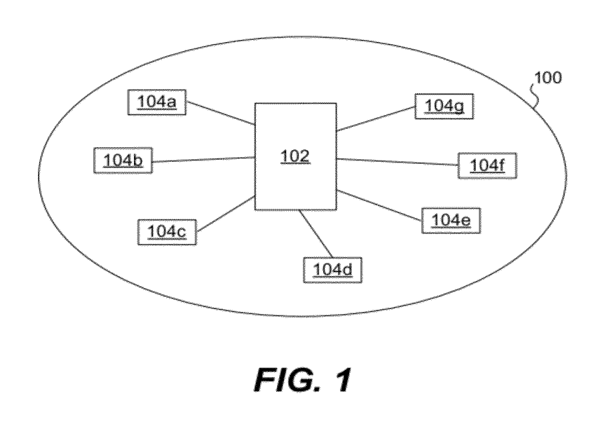

FIG. 1 is a diagram showing a generic network configuration of a distributed network in which the present invention may be implemented. A network 100 consists of one or more servers, shown as a central server 102. This server may be implemented or embodied using any known or future computer server technology. For example, it may be a home network server (in many cases, simply a desktop or laptop PC) which performs numerous other functions for the home and its users, typically family members or members of a household. It may be a server computer in a private enterprise, such as a company or a law firm, or in a public entity, such as a government agency or a public university or school. The server may also be a server application implemented on the Internet, an implementation commonly referred to as “in the cloud.” In this implementation, the hub may be hosted by a third-party. In another embodiment, hub 102 may be implemented by a third-party service provider, such as a cable TV provider, in the form of a set-top box attached to a TV.

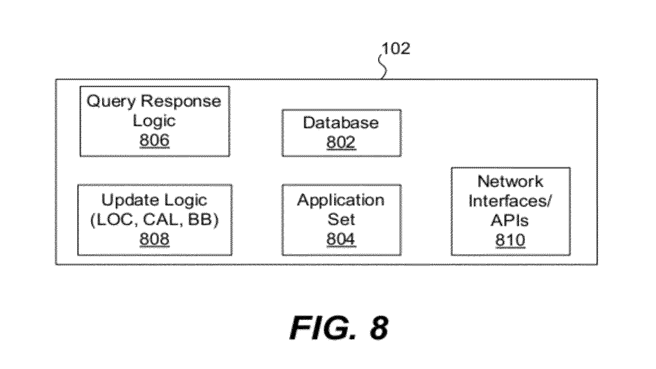

In any of these existing and future server technology implementations, server 102, whether in the cloud, in a living room, or even on a mobile device, functions as a central hub for the group-related information. It has a network-accessible database which is used as a central repository for data relevant to the group. As described below, central server or hub 102 executes applications related to the present invention and stores group-related information in addition to performing other server-related activities and storing various other types of data. It may also be noted that central hub 102 may have multiple APIs for implementing different physical transport or message passing infrastructures, allowing it to communicate with various types of devices. Central hub 102 is described in greater detail in FIG. 8.

Hub 102 is able to communicate with at least one device, such as device 104a, and will typically communicates with two or more devices, shown as devices 104a to 104g. The lines between devices 104a-g and hub 102 indicate bi-directional communication which can be wired or wireless (there may also be communication channels directly between certain devices, but they are not relevant to the present invention). The devices primarily fall in the category of consumer electronic devices that are capable of Internet connectivity and can run applications. They include mobile phones, including smartphones (sometimes called “app phones”), TVs, tablet computing devices, digital picture frames, mobile gaming devices, e-book readers, IP-enabled media players, such as MP3 players, navigational devices, desktop, laptop, or netbook PCs, large-surface computing devices, IP-enabled digital cameras and camcorders, among others devices.

The present invention utilizes existing and emerging capabilities available in these and other electronic devices. For example, presently mobile phones have location information, WAN access, Web browsers, and app execution capabilities. An increasing number of TVs have the ability to run apps, receive notifications, display Web content, and accept user input, for example, via a keyboard, a mobile device, or a remote control. Other devices (provided as examples above) have some or all of these capabilities. Some may have calendaring functions, mapping information, presence information, real-time notification ability, and a display. As is known in the art, these functions, or building blocks, are used in numerous electronic devices and services.

It may also be noted that the number of applications needed for implementing the present invention on devices 104a-g may vary depending on what type of device is running the invention. It may also be noted that the devices are not technically divided into categories or classes. From a technical standpoint, the devices are treated the same and their functionality will depend on their hardware specifications and software/firmware capabilities. However, some devices will generally be suitable for displaying as well as transmitting information, such as a PC, a tablet computing device, or a smartphone. These may be seen as both producers and consumers of information. Others may be more adaptable or suitable for displaying information (information consumers), such as TVs and digital photo frames, and may not be used as often for producing information. That is, users, for example, may not be accustomed to entering or typing in information onto a touch screen of a digital photo frame or using a keyboard for a TV (although this is a trend that may change as TVs become more advanced). Some devices may be predominantly information producers, such as navigational (GPS) devices and more conventional (previous generation) cell phones, which may be used mostly for providing (producing) location information of its user to other users in the group network.

The capabilities of the various devices and the functionality of hub 102 enable a convergence or integration of, for example, mobile devices, TVs, and tablet PCs (to name a few of the more the more widely-used devices) over the Internet. These capabilities and functionality allow users, who may be traveling with their smartphones or at home watching TV, to exchange and display information relevant to a close group of user in a manner that is not intrusive and does not require activity awareness on every device, such as on the TV. That is, the TV or other device does not have to explicitly participate in the activity. The information is collected and interwoven into the network and displayed where it needs to be. The user does not have to tell the device how to execute or what to do next.

As noted, FIG. 1 shows a generic network configuration having central hub 102 and devices 104a-g. For the purposes of describing the present invention, rather than referring to a generic configuration, it is helpful to occasionally refer to a specific environment in which central hub 102 is used. This is strictly for ease of illustration and is not intended to limit embodiments of the present invention. One environment in which the present invention is particularly useful is in the family setting. In this described embodiment, central hub 102 may be referred to as a family hub in the described embodiment. The users are family members or members of a household and may include other family members who do not live in the same home, but are granted certain privileges by an administrator. In the family setting, devices 104a-g may typically include smartphones, IP-enabled media playback devices (e.g., iPod Touch), laptop PCs, desktop PCs, and TVs. Family hub 102 may be a home network server. Other possible environments in which the present invention can be used include, for example, classrooms (where students and the teacher are users) and in a wide variety of work settings, where the users are co-workers in a company or other entity, and where it would be useful for them to share and manage group-related information. This may be particularly useful where the level of sharing and information management needed goes beyond what is presently enabled by basic e-mail communication and document sharing. In the family or home environment, users can share location information, calendaring or scheduling information, chores/task assignments, bulletin board-type information, and the like, all in real-time. Some of this information, such as location data and scheduling data, may be looked at over time to examine trends and get long-term historical information. For example, a parent can see where his children have spent the most time over the last six months which child has done the most household chores or which family members have been offline the most (and at which times), and the like. The information can be used in a wide variety of ways and may be very useful to group members.

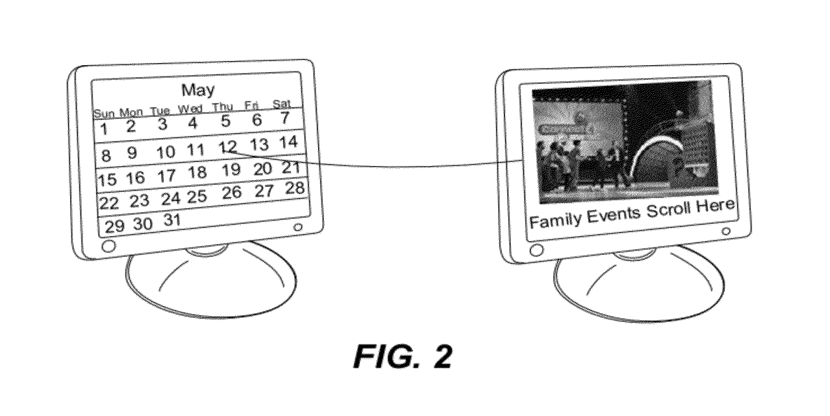

FIG. 2 is an illustration showing the concept of a ticker displayed on a TV to convey information in accordance with the described embodiment. It shows only one scenario in which family information may be displayed to users. There are many others, however, the one shown in FIG. 2 illustrates the concept of a family ticker, described below, most clearly. A device 202 may be a TV or a computer showing a calendar 204 that is used by a family to keep track of scheduling. It may have information regarding the date and time for events, related either to individual users of the family (e.g., “Cindy piano lesson at school Monday 4 to 5”) or related to the whole family. In one embodiment, information on calendar 204 is displayed on TV 206 in the form of a scroll or ticker 208 at the bottom of the display. Ticker 208 is used to access timely family (or other group) related information. It is displayed on the TV, for example, and possibly on other devices in the network, in a non-intrusive manner.

One aspect of the family ticker concept is that the mobile phone does not have to be the only device that users can use to get information. The information provided is richer, more timely, and informative than notifications that simply appear in a scroll at the bottom of the TV screen or any other display. In other embodiments, there may be a notification icon or symbol on the screen that there is information that the TV viewer may want to see. Ticker 208 is displayed on the TV screen regardless of what content is being shown on TV 206 or where the content is coming from (e.g., cable, satellite, DVD player, PC, camcorder and the like). The ticker information is always made available to TV 206 from calendar 204 as long as the TV is powered on. Calendar 204 is only one example of a source of family information that can be displayed on TV 206. As described below, various types of information and updates from family hub server 102 may be shown on TV 206 in the form of a scroll or ticker 208. Ticker 208 is one example of a light-touch or minimally intrusive interaction that characterizes the viewing experience when displaying family hub information. By having a scroll or ticker, for example, the viewer's experience of watching TV is kept intact; the intrusion is minimal yet the family hub information conveyed is rich, timely, and relevant. Family ticker 208 is one example of how group information can be displayed to users in a manner that is integrated with the TV viewing experience. If a user wants more in-depth information, she can obtain such information from the family hub database by interacting further with the family hub. What is shown in ticker 208 is an initial display of information and more detailed and related information may be obtained by interacting with TV 206 using any suitable means, such as a keyboard or remote control.

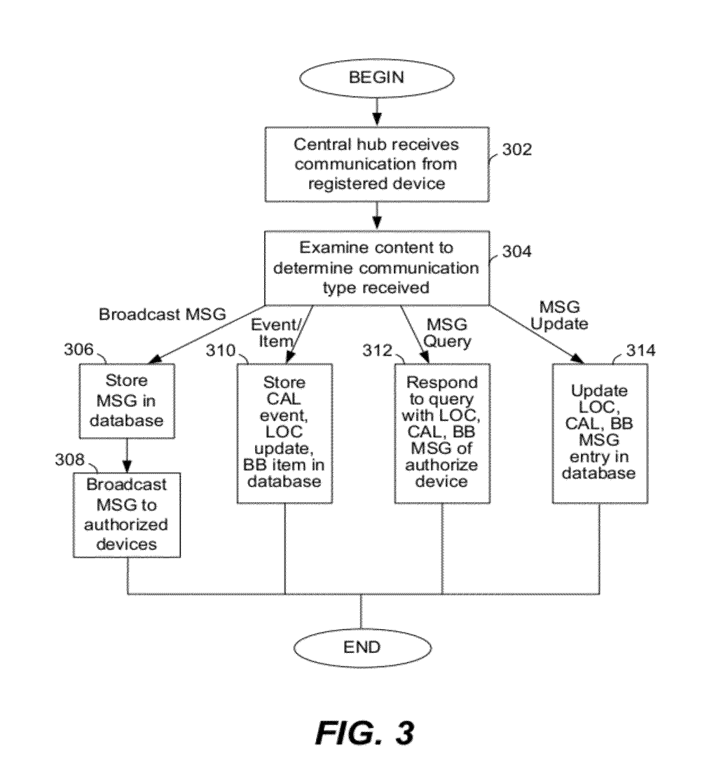

FIG. 3 is a flow diagram of processes that execute on central hub 102 that relate to receiving communications from network devices. It shows some typical or normal-course operations relating to receiving messages at central hub 102. At step 302 the central hub receives a communication from a registered device (e.g., from devices 104a-g) in the network. As described below, a communication may be a message, an event, an update, an item, a query, and the like. As noted, there is a wide range of different devices that can transmit information to the central hub. The communication may be received through one of one or more APIs operating in central hub 102. At step 304 the central hub determines what type of communication was received. In one embodiment, this may be done by examining the header of the data packets comprising the communication. Other suitable methods may be implemented by the central hub to determine the communication type. Once the type is determined, in one embodiment, one of four different operations may occur, as shown by the four arrows from step 304.

If the communication is determined to be a broadcast message from a registered device in the network, control goes to step 306 where the message is stored in a central hub database. The database, for example, a relational database, may have one or more tables used specifically for storing messages from devices. At step 308 the central hub transmits or broadcasts the same message that it received to other authorized devices in the network. Which devices are authorized to receive the particular message is determined by settings and filters. The server can be configured, using such settings and filters, to selectively send broadcast information. This allows certain devices to send and view information, but keep their users from being overly interrupted with broadcast messages, many of which may not of high relevance or interest to all users. This may be described as a centrally-administered device model.

[Broadcasting msg selection, p. 7 process for selective broadcasting] A process of selective broadcast (or how central hub transmissions are decided) begins with the central hub server receiving a broadcast message that is to be sent to all devices. The server may then load a list of devices on its network (e.g., network 100 in FIG. 1). Devices that have messages disabled, that is, which are not currently configured to receive messages, are removed. The server may then load a list of users who are currently connected to the network or logged onto the central hub system. The server then removes devices based on the list of users who have messages disabled. For example, family members who do not want to receive broadcast messages. The broadcast message is then sent to the devices remaining on the list. In other embodiments, additional or fewer filters may be used to determine which devices should receive a broadcast message at any given time. Means for delivering the broadcast message to the remaining devices may also vary and may be set up by the users or the administrator. For example, e-mail, SMS, IM, and other messaging mechanisms may be used by the server to broadcast the message at step 308.

Returning to step 304, if the central hub determines that the communication is an event/item, control goes to step 310 where the central hub stores the event or item. Examples include a calendaring (scheduling) event, a user or device location update, or a “bulletin board” (“BB”) item, such as a task, assignment, or chore. A location update may be in response to a “server notice,” explained below. Other types of events and items may also be implemented.

If the communication is determined to be a message query from a device at step 304, control goes to step 312. The message query may be related to location, calendaring, or bulletin board messages of another device. For example, a query may comprise requesting the location of another user in the network, such as a parent requesting the location of a child or wanting to know when a certain event (e.g., a birthday party) is taking place. At step 312 the server responds to the query with a location, calendaring information, or a bulletin board message. The server retrieves the data needed for responding to the query from the database using techniques known in the art.

Returning to step 304 for the fourth option, if the server determines that the communication received from a device is a message update relating to location, calendaring, or the bulletin board, at step 314 the update or change relating to one of these items is made to the specific entry in the database.

With respect to the operations described in FIG. 3, it is worth noting that the server, or central hub, can receive a device connection at any time. As noted above, the central hub can receive a “server notice.” These notices can be pushed to a device, specifically a mobile device, using cellular phone networks or other delivery mechanisms. The server notices can also be pushed to devices having active Internet connections using an active TCP/IP connection established by the device. Other delivery mechanisms include only text messages (e.g., SMS). Mobile devices can use the cellular network connection to receive server notices when they are disconnected from the server and can use an active Internet connection when they are connected to the server. Devices that do not have cellular network connections, such as a TV or PC (e.g., running a Family Hub App) can use Internet connections to receive server notices.

An important aspect of the present invention is the device to server connection and communication. A device will generally connect to a server using secure communication means, such as SSL. The user of the device provides login information and a password and the server verifies this information by checking for an account and validating the password. If valid the device is authorized for communication with the server. The device may disconnect from the server and in the case of mobile devices using cellular networks, the device can still receive server notices using the network. When they are connected, they can use the cellular network or TCP/IP connections.

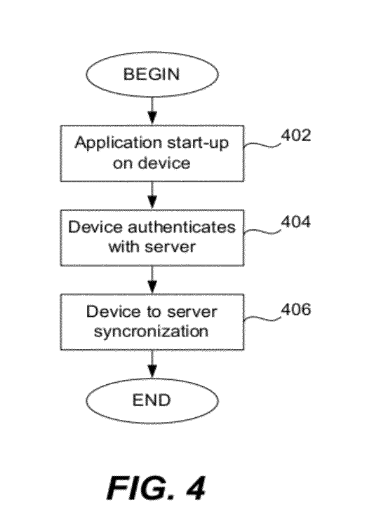

FIG. 4 is a flow diagram of a process of a device connecting to a server. At step 402 the application, such as the Family Hub application, starts up on a user device, such as a TV, a digital photo frame, or a tablet computer. Once the application starts up and the user is logged onto the application, at step 404 the device authenticates itself with the server in order to establish the credentials of the device with the server. The server can receive device connection requests at anytime. At step 406 a data synchronization is performed between the device and the server. The device receives any updates from the server of information that is stored on the device and the server is updated with data from the device. This type of data synchronization may be done using programming techniques known in the art. After step 406 the device is ready to operate on the network. It may be noted here that once the device is connected to the server, it may send a communication or essentially “ping” the server on a regular or periodic basis. This may be useful as an administrative tool for monitoring online status for a particular user or device over time. In effect, it allows users to measure other users level of participation in the group-data sharing network. For example, in the family hub environment, a parent may be able to monitor how often a child is offline (or not using the family hub application) by looking at the number of pings the server received from a particular device over time. If the child's mobile device should be online every weekday from 2 to 5, but the server is not receiving pings from the device from 3:30 to 4:30 on most weekdays, the parent knows that the child is turning the device off or logging off the family hub application during that time.

On the subject of device authentication, as mentioned above, note that devices may or may not be authenticated. This is an implementation decision. One possible implementation is using out of band signaling to verify ownership, such as sending a text message or e-mail to a registered user. There are various ways to implement device authentication. Similarly, users may or may not be authenticated. For example, a user may be authorized by a moderator, a password or passcode may be used, or an e-mail invitation may be sent to the registered account holder. Once authenticated, a user can access the system with the username and passcode.

With respect to user authentication, an example using the family hub embodiment may be helpful. A family hub server is configured to accept or allow registration applications, which are used by individual family members (or non-family members) to apply to be in the family or network. Server registrations can be allowed or disallowed. A user accesses the family hub Web site and registers using a top-level system name. The user may then create a username and passcode and enter account information. The request may then be logged and awaiting approval by an administrator (e.g., a parent). An administrator authorizes the account and then the account is marked active and the user is activated. This process may be favored, for example, by Internet service providers.

In another embodiment, the family hub server has an “activation code” set by an administrator. The user is given the code, for example, in the form of a card from a cellular network carrier. The user may then go to the family hub Web site and register using the activation code. The user then creates a username, passcode and enters account information, after which the user is activated. The process may be favored by cellular network carriers.

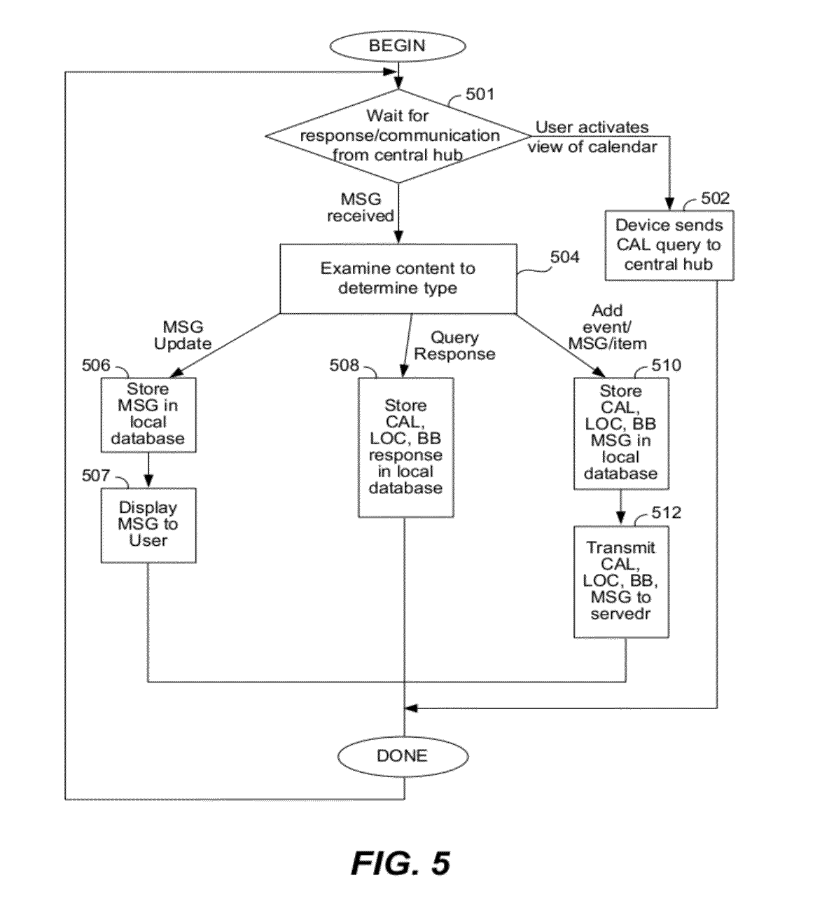

FIG. 5 is a flow diagram of some typical operations that execute on a device in accordance with one embodiment. At step 501 the device waits for a communication or, if the device sent a query, a response from the central hub. During this wait period, the device user may activate or bring up a view of the calendar. Upon calendar activation, at step 502 the device sends a calendar (CAL) query to the central hub, at which point the calendar view process is done. The process then returns to the beginning where the device waits for a response or communication from the central hub as described at step 501.

If at step 501 the device receives a message (MSG), control goes to step 504. At step 504 the device examines the content of the message, for example, the header or other component of the message, to determine the communication type. This may be done, for example, by a family hub application running on the device. Depending on the communication type, in one embodiment, one of three operations may occur as indicated by the three arrows from step 504.

If the communication is a message update, the message is stored on a local database on the device at step 506. One requirement of a device, besides being able to run apps, is that it has data storage or memory. The message is pushed to the device from the server (which follows policies and settings with respect to which devices receive the message update) and may reflect an update on the overall state of the system. The message update may be a server notice. The device may be configured to enable or disable the ability to receive broadcast messages from the server. In one embodiment, this may only be done using an administrative setting on the server. This may prevent, for example, a child from disabling her mobile device from receiving such messages. In another embodiment, the user of a device can also enable or disable broadcast messages while they are using the device. It is also possible to have both these capabilities.

At step 507 the update is displayed to the user. As noted, this may be done in one of a number of ways depending on the device. If it is a TV, it may be displayed using a ticker at the bottom of the screen. If it is a tablet computer, it may be displayed using a notification (similar to a text message or e-mail message notification).

If the communication is a response from the server to a query made by the device, control goes to step 508. This is a continuation of the process described at step 312 of FIG. 3 where the server responds to a query with a specific type of information. At step 508 the device stores the response in a local database. The response may be a calendaring event, location information, a bulletin board item, and the like.

If the communication is the result of the user of the device adding an event, message, or item to the system, control goes to step 510. This may happen if the user types in a message, enters something on the calendar, or moves to another location (in which case the location item may be added automatically to the device). For example, if a user moves from a school to a friend's house, this location information will be added to the device database automatically and eventually forwarded to the server, as described in step 512. The event, message, or item is stored in a local database on the device at step 510. At step 512 the event/message/item is transmitted to the server. In one embodiment, these communications may be queued on the device for transmission to the server at a later time (a ‘store-and-forward’ implementation). The content of an event may vary from something very basic to a detailed communication. For example, it may contain pictures, video, music, and the like. However, in one embodiment, only a portion of the event (depending on how much data is used to convey the event) may be transmitted to the server. After steps 502, 507, 508, and 512, the processes are done and control goes back to step 501 where the device waits for a response or communication from the central hub.

As noted above, many mobile devices have built-in location determination capabilities. They know where they are with varying degrees of specificity. Location information can also be entered manually by a user. A location transmission policy may be included in the application set for implementing the present invention (e.g., family hub application set). This location transmission policy may be changed by a designated administrator, such as a parent in the family hub environment. This administrator may be one, multiple, or all users of the network.

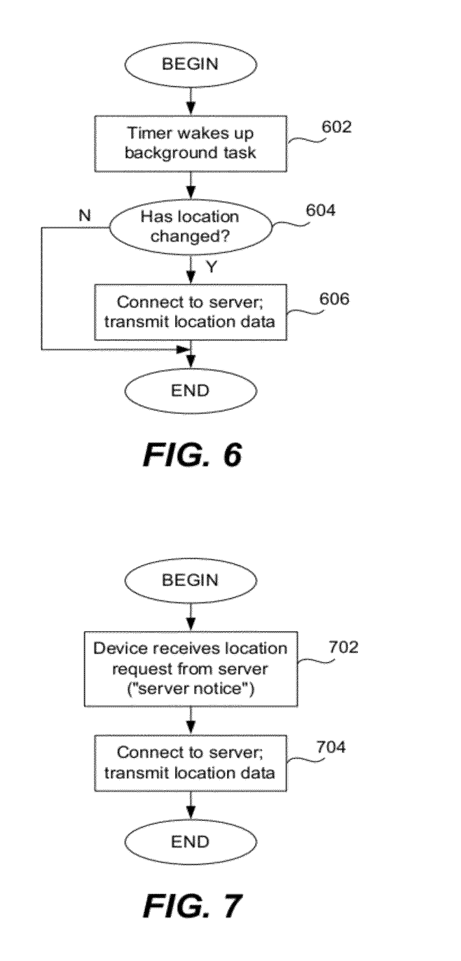

FIG. 6 is a flow diagram showing a process of a background task maintaining location status on a mobile device. At step 602 a timer on the device wakes up or invokes a background task related to determining device location. At step 604 the device determines whether the location has changed. New location information may also be manually entered by a user. If it has changed, control goes to step 606 where the device connects to the central hub (if not already connected) using processes described above. It then transmits the new location data to the server. If the location has not changed, the background task returns to idle or sleep mode.

FIG. 7 is a flow diagram of a process of providing location information in response to a server request. At step 702 a device receives a location request from the server. This may be in the form of a server notice, as described above. At step 704 the device connects to the server, if not already connected, using processes described above, and transmits location data to the server. The server stores and may then broadcast this information or send it to specific users.

FIG. 8 is a block diagram of a central server or hub shown as server 102 in FIG. 1. Hub 102 has a database 802 residing in a data storage component 803. Database 802 stores all types of data relating to the group (e.g., the family), the devices, and the server, such as messages, event data, location information, calendaring information, bulletin board data, user names, passcodes, account data, and other types of data described above. Hub 102 also contains an application set 804 that includes all the applications or apps needed for implementing various embodiments of the present invention, such as the family hub server. A query response logic module 806 receives a location, calendaring, bulletin board, or message query from a device and derives a response which is sent to the device, as described in step 312 of FIG. 3. Logic module 806 may access database 802 to retrieve any necessary information. The query response may then be sent to the device via a network interface 810. Also shown is an update logic module 808 for updating location, calendaring, and various other types of information as mentioned above, in database 802. The update is received from a device and updated in server 102 as described in step 314 of FIG. 3.

In one embodiment, a family hub calendar may accept calendar invitations and notifications from other calendar systems. This facilitates the incorporation of events from other sources into the family hub network. The family hub may leverage existing calendaring technology, however, in one embodiment, the feature or application set of the present invention may focus on calendaring display and access. Family hub members may use other applications for managing their personal and work calendars. Events from personal and work calendars may be easily integrated with the family hub.

Another feature of the family hub network is the family map. Many family members use location capabilities that presently exist on many mobile phones. There are numerous existing services that use location information from the phone to facilitate searching and other applications. There are services that offer a feature that shows the location of friends on a map. The family hub performs a similar function for family members. The Family Hub map display may show the name of each family member on a map. Additional location tags can be added to the map so that important locations can be displayed along with the location of the family members. Examples are school, dad's work, mom's work, pool, friend's house, and the like. This makes it easy to see when family members are at known locations.

A family hub mobile application provides mobile access to the same information that is shown on an in-home device, such as a TV or a digital picture frame. The mobile application set may also activate the location reporting feature, so a family member's location is displayed to other family members. In one embodiment, the mobile version also includes a version of the family ticker, but the text messaging feature of the phone may be utilized for real-time updates.

An example of how the family hub network may be used to send a broadcast message is helpful in understanding the present invention. This example is provided simply for illustration and is not intended to limit the invention or any embodiments to the family environment or to solely sending broadcast messages. In this example, a system configuration may be comprised of the following:

One (1) Family Hub Server—Svr1

Family Hub server is active at all times

Two (2) Family hub mobile devices—Dev1, Dev2 (devices are active in this example)

Family Hub mobile device automatically share LOC information on periodic basis.

Family Hub broadcast messages “pop up” when received on the mobile device.

Family Hub mobile application is active only when the user activates it.

One (1) Family Hub TV—TV1

Family Hub TV1 is active only when powered on, and in use.

Family Hub TV1 is active in this example, and User3 is watching TV1.

Three (3) Family Hub users: User1, User2, User3.

A use case may be as follows. User1 of Dev1 activates the Family Hub application on her mobile phone (Dev1). The same user touches/activates the “send message” option of the family hub application. The family hub application then displays a dialog box on Dev1 that allows User1 to type a message. User1 types a message “Going to Sara's house after school” and presses the “send” button on the family hub mobile application. The family hub mobile application on Dev1 stores the message locally and transmits the message to Svr1. Svr1 acknowledges receipt of the message from Dev1 and stores the message in the Svr1 database. Svr1 then transmits the message “Going to Sara's house after school” to Dev2 and TV1. User2 receives a beep tone and “pop up” message on his mobile phone showing the username/friendly name of User1. The message “Going to Sara's house after school” is sent to User3 who sees a ticker or scrolling banner message on TV1 showing the username/friendly name of User1, and the message “Going to Sara's house after school” in the ticker.

In one embodiment, a user can program a setting such that only text messages are sent as an alternative delivery system. In another embodiment, the system may support communication between devices. For example, a user 1 may send a message from device 1 to a server, where the message is tagged for a user 2. User 2 connects to the server and queries for messages tagged for user 2. The server may respond with messages tagged for user 2.

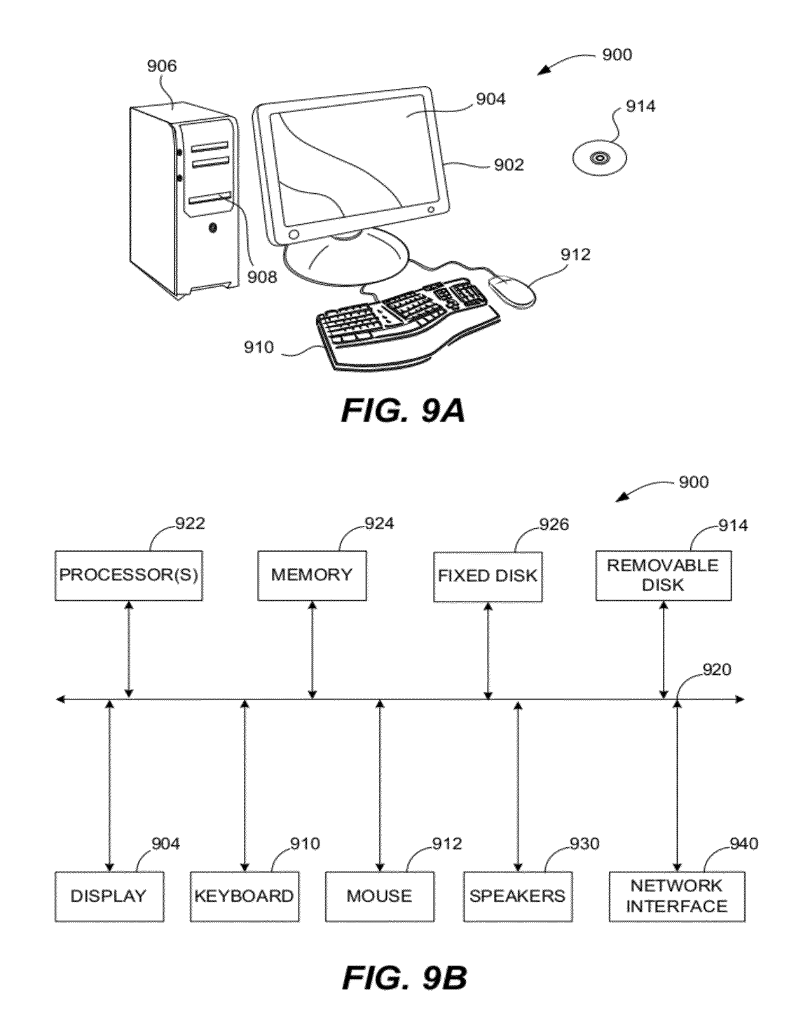

FIGS. 9A and 9B illustrate a computing system 900 suitable for implementing specific embodiments of the present invention, such as central server 102 or devices 104a-g. FIG. 9A shows one possible physical implementation of a server or other computing system, such as a tablet computer, a PC, or the internals of a smartphone. In one embodiment, system 900 includes a display 904. Certain components of the present invention, such as server 102 may not have a display. It may also have a keyboard 910. It may have various ports such as HDMI or USB ports (not shown). Computer-readable media that may be inserted or coupled to computing device 900 may include a CD-ROM, USB memory devices and various types of memory chips, sticks, and cards.

FIG. 9B is an example of a block diagram for computing system 900. Attached to system bus 920 is a variety of subsystems. Processor(s) 922 are coupled to storage devices including memory 924. Memory 924 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to processor 922; it provides additional data storage capacity and may also include any of the computer-readable media described below. Fixed disk 926 may be used to store programs, data and the like and is typically a secondary storage medium that is slower than primary storage. It will be appreciated that the information retained within fixed disk 926, may, in appropriate cases, be incorporated in standard fashion as virtual memory in memory 924.

Processor 922 is also coupled to a variety of input/output devices such as display 904 and network interface 940. In general, an input/output device may be any of: video displays, keyboards, microphones, touch-sensitive displays, tablets, styluses, voice or handwriting recognizers, biometrics readers, or other devices. Processor 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon processor 922 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What we claim is:

1. A method of managing group information stored on a central server, the method comprising:
examining a communication received from a device;
determining whether a type of the communication is a broadcast message, an event message, a query message, or an update message;
storing the communication in a database on the central server if the communication is a broadcast message or an event message;
responding to the communication if the communication is a query message; and
updating the database in the central server if the communication is an update message;
wherein a portion of the group information from the server is displayed in real-time in a minimally intrusive manner on a device and in a manner that does not interfere with normal use of the device.

2. A method as recited in claim 1 further comprising:
integrating a group information ticker with a specific viewing experience for a user, wherein the group information ticker is used to access group information.

3. A method as recited in claim 2 wherein the group information ticker is displayed on a television.

4. A method as recited in claim 1 further comprising:
enabling examination of detailed group information, wherein specific information is shown briefly during a viewing experience before the detailed information is shown for examination.

5. A method as recited in claim 1 wherein the device connects to the central server and the server transmits a special type of communication to the device on periodic basis to determine the connectivity and other information of the device.

6. A method as recited in claim 1 wherein the server logs device connection status and obtains historical data.

7. A method as recited in claim 1 wherein group information includes calendar event information, location and status information, bulletin board information, and task lists.

8. A method as recited in claim 1 wherein the device is primarily an information producer.

9. A method as recited in claim 1 wherein the device is primarily an information consumer.

10. A method as recited in claim 1 further comprising:
examining a portion of the group information to determine trends and get long-term historical information.

11. A method of managing group information on a device, the method comprising:
examining a communication received from a server;
determining whether a type of the communication is a broadcast message or a query response, wherein the communication may be a calendaring event, location information, or a bulletin board item; and
storing the communication in a device database.

12. A method as recited in claim 11 further comprising:
determining that a user of the device is making an update to group information;
storing the group information in a local database on the device; and
transmitting the update of the group information to the server.

13. A method as recited in claim 11 further comprising:
displaying the broadcast message on the device.

14. A method as recited in claim 12 wherein a portion of the group information is transmitted to the server.

15. A method as recited in claim 11 further comprising displaying a group information ticker on a TV.

16. A method as recited in claim 11 wherein group information includes calendar event information, location and status information, bulletin board information, and task list information.

17. A method as recited in claim 11 further comprising:
receiving a periodic communication from the server to determine connectivity and other information relating to the device.

18. A method as recited in claim 11 further comprising:
receiving server communications over one of a cellular network or a TCP/IP network.

19. A method as recited in claim 11 further comprising:
transmitting a query from the device to the server.

20. A system for facilitating group information communication and management, the system comprising:
a group server having a database and a group information server application set, wherein combined group information is stored in the database; and
a plurality of devices, wherein one or more of the devices displays a group-information ticker and has a group information client application set, wherein the group-information ticker displays a portion of group information and does not interfere with the normal use of a device;
wherein interactions among group members are integrated with a primary function of the device and provide minimally intrusive notifications of activity.

21. A system as recited in claim 20 wherein the group server receives broadcast messages, event/item information, queries, or updates.

22. A system as recited in claim 20 wherein a device receives messages from the server and query responses from the server.

23. A system as recited in claim 20 wherein the plurality of devices includes a cell phone, a TV, a digital picture frame, a desktop PC, a laptop computer, a tablet computing device, and a mobile gaming device.

24. A system as recited in claim 20 wherein the group-information ticker accesses a calendar only for group-related information.

25. A system as recited in claim 24 wherein the group-information ticker is displayed on the TV.

26. A method of disseminating group information in a distributed network, the method comprising:
transmitting a communication from a first device, wherein the communication is either sent by a user of the device or is automatically sent by the device;
receiving the communication at a central server;
updating a database on the central server;
transmitting the communication from the central server to a second device;
displaying the communication on the second device in real-time in a minimally intrusive manner that does not interfere with the normal use of the second device and enabling interaction; and
displaying the communication on other registered devices in the distributed network.

27. A method as recited in claim 26 wherein updating a database in the server further comprising:
updating group member location data;
updating group calendar events;
updating a group bulletin board; and
updating a group tasks list.

28. A method as recited in claim 26 further comprising:
enabling a second user on the distributed network to engage in more in-depth interaction with the second device to see more information relating to the communication or other group information.

29. A method as recited in claim 26 wherein the message contains group information.

30. A method as recited in claim 26 wherein displaying the communication further comprises:
scrolling the group information in the form of a ticker displayed at the bottom of a TV screen.
